(19) United States
(12) Patent Application Publication
(10) Pub. No.: US 2013/0054738 A1
(43) Pub. Date: Feb. 28, 2013

(54) DATA COMMANDS FOR PERSONAL WIRELESS NETWORK DEVICES

(71) Applicants: Daniel R. Borges, San Francisco, CA (US); Abuzar Amini, San Jose, CA (US); Jim Wilcox, Sunnyvale, CA (US)

(72) Inventors: Daniel R. Borges, San Francisco, CA (US); Abuzar Amini, San Jose, CA (US); Jim Wilcox, Sunnyvale, CA (US)

(73) Assignee: APPLE INC., Cupertino, CA (US)

(21) Appl. No.: 13/282,275

(22) Filed: Oct. 26, 2011

Related U.S. Application Data
(60) Provisional application No. 61/526,180, filed on Aug. 22, 2011.

(51) Int. Cl. G06F 15/16

(52) U.S. Cl. 709/217

(57) ABSTRACT

Data commands for a personal wireless network device are described herein to improve usability of such devices and to enhance the overall user experience with such devices. According to one embodiment, the commands are sent from a personal computing device via a serial communications mechanism to the personal wireless network device. At least three different commands are contemplated: a Configuration Network Address Request command, a Billing Network Address Request command, and a Service Type Request command.

### CROSS-REFERENCE TO RELATED APPLICATIONS; BENEFIT CLAIM

This application claims the benefit of Provisional Appln. 61/526,180, filed Aug. 22, 2011, the entire contents of which is hereby incorporated by reference as if fully set forth herein, under 35 U.S.C. §119(e).

### FIELD OF THE INVENTION

The present invention relates to data commands for obtaining certain information from personal wireless network devices.

### BACKGROUND

Personal wireless network devices are an increasingly popular way to connect a personal computing device such as laptop computer, a desktop computer, a tablet computer, or a smart phone to a data network such as the Internet. In some configurations, the personal wireless network device is communicatively coupled to the personal computing device by a serial communications mechanism (e.g., Ethernet, FireWire, Universal Serial Bus (USB), etc.). The personal wireless network device may include a radio transmitter and receiver for sending and receiving data to and from a radio network such as a cellular network. The radio network in turn may be connected to a data network such as the Internet. Data sent from the personal computing device destined for the data network may be sent to the personal wireless network device via the serial communications mechanism and then sent by the personal wireless network device to the data network via the radio network. Data sent from the data network destined for the personal computing device may be received by the personal wireless network device from the radio network and then sent by the personal wireless network device to the personal computing device over the serial communications mechanism. In this way, a user of the personal computing device can perform various online functions such as browsing the web, checking e-mail, etc.

Many personal wireless network devices include a web server for configuration purposes. Typically, the web server in a personal wireless network device is capable of presenting a user interface in a web browsing application that accesses the web server. A user of the web browser may configure the personal wireless network device by providing configuration information to the web server through the user interface. Through the user interface, the user may configure various possible features of the personal wireless network device such as, for example, wireless connectivity, Internet connectivity, firewalling, hotspot setup, port forwarding, etc.

Often, the web server in a personal wireless network device is accessed by a web browser executing on the personal computing device to which the personal wireless network device is coupled via the serial communications mechanism. To access the web server, the user of the personal computing device typically must know beforehand the network address (e.g., domain name, Internet Protocol (IP) address, Uniform Resource Locator (URL), etc.) to which the user should direct the web browser to access the web server. Typically, this network address is pre-determined by the manufacturer of the personal wireless network device and is specified in a user manual accompanying the personal wireless network device. For example, the network address may be a private IP address such as 192.168.1.1. If the user knows the network address, the user may direct the web browser to access the web server at the network address by, for example, entering the network address in the address bar of the web browser.

Unfortunately, there is no standard network address at which all configuration web servers of personal wireless network devices can be reached. This is unfortunate because if the user manual is lost or otherwise unavailable the user may be unable to access the configuration web server and thus may not be able to configure the personal wireless network device. The user may attempt to guess the network address. However, the user may become frustrated if unable to correctly guess the network address on the first attempt or after many attempts.

Accordingly, there is a need for a technique that allows a user to gain access to the web interface provided by a configuration web server of a personal wireless network device that does not require the user to know the network address of the web server.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

Data commands for personal wireless network devices are described herein to improve usability of such devices and to enhance the overall user experience with such devices. According to one embodiment, the commands are sent from a personal computing device via a serial communications mechanism to the personal wireless network device. At least three different commands are contemplated.

### BRIEF DESCRIPTION OF THE DRAWINGS

The present invention is illustrated by way of example, and not by way of limitation, in the figures of the accompanying drawings and in which like reference numerals may refer to similar elements and in which:

FIG. 1 is a block diagram of a system that is configured to use one or more of the three data commands described herein.

FIG. 2 is a block diagram of a personal computing device configured to use one or more of three data commands described herein.

FIG. 3 is a screenshot of a user interface generated in part based on a response to one of the three data command described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Configuration Network Address Request Command

A first of the three commands is referred to herein as the “Configuration Network Address Request” command, or just “CNAR” command for short. According to one embodiment, the personal wireless network device, in response to receiving a CNAR command from the personal computing device, returns to the personal computing device a network address at which the personal computing device can reach a configuration web server of the personal wireless network device. This network address is referred to herein as the “configuration network address”. With the CNAR command capability in the personal computing device and the personal wireless network device, the personal computing device can obtain, for the user, the configuration network address of the configuration web server from the personal wireless network device without the user having to know, guess, lookup, or enter the network address.

In one embodiment, the returned configuration network address is either a complete URL or a partial URL that indicates where a web page served by the configuration web server of the personal wireless network device can be obtained by the personal computing device and a mechanism for retrieving the web page. A complete URL is a data character string that contains a specification of at least a protocol scheme and a domain name or IP address. An example of a complete URL is “http://192.168.1.1”. A complete URL may also specify, among other URL components, a port number and a path. A partial URL is data character string that contains a specification of at least a domain name or IP address. An example of a partial URL is “192.168.1.1”. A partial URL may also specify, among other URL components, a port number and a path.

In one embodiment, the web page indentified by the complete or partial URL is the initial or main web page of the web interface for configuring the personal wireless network device. However, the complete or partial URL may refer to another web page served by the configuration web server and is not limited to referring to just the initial or main web page.

In one embodiment, the mechanism for retrieving the web page is either the HyperText Transfer Protocol (HTTP) or the Secure HyperText Transfer Protocol (HTTPS). However, other mechanisms such as, for example, the File Transfer Protocol (FTP), may be specified in the complete or partial URL.

In one embodiment, the personal computing device, in response to receiving a configuration network address from the personal wireless network device, automatically opens a web browser window that is directed to the configuration network address thereby causing the web browser window to display to a user of the personal computing device the web page served by the configuration web server of the personal wireless network device corresponding to the configuration network address. Usability of the personal wireless network device is enhanced because the user is not required to know, guess, lookup, or enter the configuration network address. Instead, the personal computing device, by sending the CNAR command to the personal wireless network device, may obtain the configuration network address for the user and automatically open a web browser window directed to the configuration network address. A beneficial effect of the CNAR command is that the user can configure the personal wireless network device using the web interface provided by the configuration web server of the personal wireless network device without having to know, guess, lookup, or enter the configuration network address.

### Billing Network Address Request Command

A second of the three commands is referred to herein as the “Billing Network Address Request” command, or just “BNAR” command for short. According to one embodiment, the personal wireless network device, in response to receiving a BNAR command from the personal computing device, returns to the personal computing device a network address at which the personal computing device can obtain the radio network carrier's billing information web page. This network address is referred to herein as the “billing network address”.

The radio network carrier may be a radio network service provider such as a cellular network carrier, for example, that provides and facilitates, for a fee, connectivity and data transfer between the personal wireless network device and a data network connected to the radio network. The radio network carrier may maintain service billing and usage information for the user accessible through the carrier's Internet web site. With the BNAR command capability in the personal computing device and the personal wireless network device, the personal computing device can obtain for the user the billing network address of the radio network carrier from the personal wireless network device without the user having to know, guess, lookup, or enter the network address.

In one embodiment, the returned billing network address is either a complete Uniform Resource Locator (URL) or a partial URL that indicates where a web page served by radio network carrier's web site can be obtained on the Internet.

In one embodiment, the personal computing device, in response to receiving the billing network address from the personal wireless network device, automatically opens a web browser window that is directed to the billing network address thereby causing the web browser window to display to a user of the personal computing device a billing information web page served the radio network carrier's Internet web site.

Embodiments are not limited by what information is presented on the billing information web page. Some possible billing information web pages are: (1) a login page by which the user can provide credentials for accessing the user's personal service billing and/or usage information, (2) general billing and/or service usage information, and (3) the user's personal service billing and/or usage information.

Usability of the personal wireless network device and the radio network carrier's service may be enhanced because the user is not required to know, guess, lookup, or enter the billing network address. Instead, the personal computing device, by sending the BNAR command to the personal wireless network device, may obtain the billing network address for the user and automatically open a web browser window directed to the billing network address. A beneficial effect of the BNAR command is that the user can access billing and/or service usage information from the radio network carrier's Internet web site without having to know, guess, lookup, or enter the billing network address.

### Service Type Request Command

The third of the three commands is referred to herein as the “Service Type Request” command, or just “STR” command for short. According to one embodiment, the personal wireless network device, in response to receiving a STR command from the personal computing device, returns to the personal computing device current radio network service type information pertaining to the radio communications between the personal wireless network device and the radio network.

In one embodiment, the service type information includes (1) a number indicating radio signal strength between the personal wireless network device and the radio network (e.g., a number ranging from 0 to 5 with 0 indicating low signal strength up to 5 indicating high signal strength), (2) a character string indicating the current radio network mode (e.g., “UMTS”, “HSPA”, HSPA+”, “LTE”, etc.), and (3) a character string indicating the generation of the current radio network service (e.g., “2G”, “3G”, “4G”, etc.). With the STR command capability in the personal computing device and the personal wireless network device, the personal computing device can obtain relevant service information pertaining to the radio communications between the personal wireless network device and the radio network in a single command.

### Example System

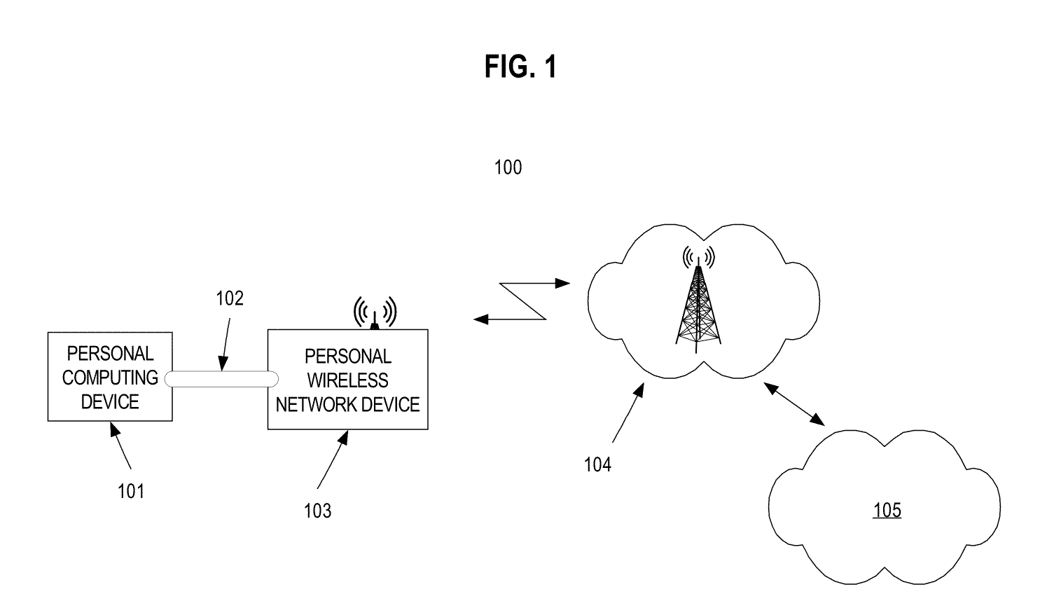

Referring to FIG. 1, it is a block diagram of a system that is configured to use one or more of the three data commands. In the example illustrated in FIG. 1, a personal computing device 101 is operatively and communicatively coupled to a personal wireless network device 103 via a serial communications mechanism 102.

The personal computing device 101 may, for example, be a desktop computing device, a workstation computer, a laptop computing device, a tablet computing device, a smart phone, a cell phone, etc.

The personal wireless network device 103 may, for example, be a wireless routing device, a Wireless Wide Area Network (WWAN) device, or any other wireless networking device that is configured to use radio signals for sending and receiving data to and from a radio network.

The serial communications mechanism 102 may be any mechanism suitable for serial data communications between the personal computing device 101 and the personal wireless network device 103. In one embodiment, the serial communications mechanism 102 is a Universal Serial Bus (USB)-based mechanism. However, other types of serial communications mechanisms are possible and embodiments are not limited to USB-based mechanisms. For example, serial communications mechanism 102 may be a FireWire-based, Ethernet-based, PCI Express-based, etc. In one embodiment, the interface between the personal computing device 101 and the personal wireless network device 103 provided by the serial communications mechanism 102 is intended to operate over existing serial (e.g., ITU-T Recommendation V.24, USB, FireWire, Ethernet, etc.) cables, infrared link, or any other serial link type suitable for implementing one or more of three data commands described herein.

Personal wireless network device 103 may be communicatively coupled to a radio network 104. For this purpose, personal wireless network device 103 includes a radio transmitter and receiver for sending and receiving radio signals to and from the radio network 104. The radio network 104 may be any network in which data is transmitted between the personal wireless network device 103 and the radio network 104 using radio waves.

In one embodiment, the radio network 104 is a mobile cellular network containing a number of fixed-location radio transceivers, cell towers, or base stations joined together to provide radio coverage over a geographic area. In this case, the radio network 104 may use any one or multiple of a number of different digital cellular technologies for sending and receiving data to and from the personal wireless network device 103 including, but not limited to, Global System for Mobile Communications (GSM), General Packet Radio Service (GPRS), Code Division Multiple Access (CDMA), Evolution-Data Optimized (EV-DO), Enhanced Data Rates for GSEM Evolution (EDGE), 3GSM, Digital Enhanced Cordless Telecommunications (DECT), Digital AMPS, Integrated Digital Enhanced Network (iDen), and others.

Radio network 104 may be operatively coupled to another data network 105 such as the Internet, a Wide Area network (WAN), a Local Area Network (LAN), etc.

In operation, personal computing device 101 sends one or more of the three data commands to the personal wireless network device 103 over the serial communications mechanism 102. The personal computing device 101 receives responses to the commands from the personal wireless network device 103 over the serial communications mechanism 102.

In operation, personal wireless network device 103 receives one or more of the three data commands from the personal computing device 101 over the serial communications mechanism 102. The personal wireless network device 103 sends responses to the commands to the personal computing device 101 over the serial communications mechanism 102.

In one embodiment, a control channel of the serial communications mechanism 102, separate from one or more data channels of the serial communications mechanism 102, is used for transmitting command data and response data between the personal computing device 101 and the personal wireless network device 103. In another embodiment, one or more data channels are used to transmit both command and response data and other data.

Logic, instructions, or programs for sending commands and receiving responses in the personal computing device 101 may be implemented in software, hardware, firmware, or some combination of software, hardware, and firmware.

Logic, instructions, or programs for receiving commands and sending responses in the personal wireless network device 103 may be implemented in software, hardware, firmware, or some combination of software, hardware, and firmware. For example, techniques described herein may be implemented in hardware by way of another device such as an application specific integrated circuit (ASIC) having elements, including logic elements, that are constructed/configured to implement techniques described herein in the personal wireless network device 103. Overall, the personal wireless network device 103 may be hardware implemented using any number of devices with elements, including logic elements, that are constructed/configured to implement techniques described herein in the personal wireless network device 103.

### At Commands

In one embodiment, each of the three commands are formatted and transmitted by the personal computing device 101 as ATtention command lines as follows:

CONFIGURATION NETWORK ADDRESS REQUEST AT COMMAND

| AT Command | Possible Response |
|---|---|
| +CONFIGURL? | +CONFIGURL: <url_string> |

In one embodiment, the CNAR AT command causes the personal wireless network device 103 to return a single line of text formatted as a complete or partial URL between double quotes that indicates a configuration network address of a web page served by a configuration web server of the personal wireless network device 103. In one embodiment, the total number of characters, including line terminators, of the <url string> does not exceed 1024 characters and does not contain the characters sequences 0<CR> or OK<CR> where <CR> stands for carriage return.

BILLING NETWORK ADDRESS REQUEST AT COMMAND

| AT Command | Possible Response |
|---|---|
| +BILLINGURL? | +BILLINGURL: <url_string> |

In one embodiment, the BNAR AT command causes the personal wireless network device 103 to return a single line of text formatted as a complete or partial URL between double quotes that indicates a billing network address of a web page containing billing and/or service usage information served by an Internet web site of the radio network 104 carrier. In one embodiment, the total number of characters, including line terminators, of the <url_string> does not exceed 1024 characters and does not contain the characters sequences 0<CR> or OK<CR> where <CR> stands for carriage return.

SERVICE TYPE REQUEST AT COMMAND

| AT Command | Possible Response |
|---|---|
| +SERVICETYPE? | +SERVICETYPE <signal_bars>, |
| | <network_mode_string>, |
| | <service_generation_string> |

In one embodiment, the STR AT command causes the personal wireless network device 103 to return the current service type expressed in three parameters that allows the personal computing device 101 to determine current relevant radio network 104 service information from a single AT command.

In one embodiment, <signal_bars> is an integer ranging from 0 to 5 indicating to the personal computing device 101 the number of signal bars to display when visually representing the radio signal strength between the personal wireless network device 103 and the radio network 104.

In one embodiment, <network_mode_string> is a text string contained within quotes indicating to the personal computing device 101 the current cellular radio network mode (e.g., UMTS, HSPA, HSPA+, LTE, etc.) in use by personal wireless network device 103 for communicating with the radio network 104.

In one embodiment, <service_generation_string> is a text string contained within quotes indicating to the personal computing device 101 the generation (e.g., “2G”, “3G”, “4G”, etc.) of the current cellular radio network service in use by personal wireless network device 103 for communicating with the radio network 104.

The above are just some examples of how the three commands may be formatted as AT commands. However, other AT command formats are possible and embodiments of the invention are not limited to the example formats above. Further, embodiments are not limited to an AT command format and in alternative embodiments, different data formats (e.g., eXtensible Markup Language (XML)) may be used. Thus, the above are merely examples of the various ways in which the three data commands and response thereto may be formatted.

### Sample Personal Computing Device

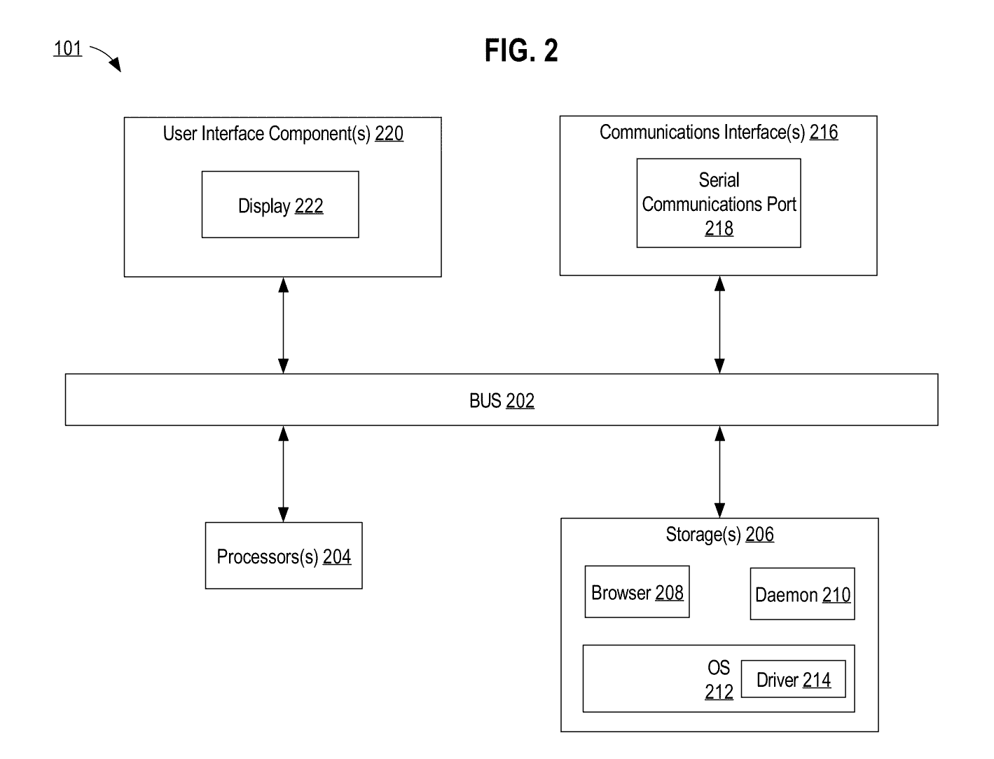

With reference to FIG. 2, there is shown a block diagram of a sample personal computing device 101 in which one embodiment of the present invention may be implemented. As shown, device 101 includes a bus 202 for facilitating information exchange, and one or more processors 204 coupled to bus 202 for executing instructions and processing information. Device 101 also includes one or more storage(s) 206 (also referred to herein as non-transitory computer readable media) coupled to the bus 202. Storage(s) 206 may be used to store executable programs, permanent data, temporary data that is generated during program execution, and any other information needed to carry out computer processing.

Storage(s) 206 may include any and all types of storages that may be used to carry out computer processing. For example, storage(s) 206 may include main memory (e.g. random access memory (RAM) or other dynamic storage device), cache memory, read only memory (ROM), permanent storage (e.g. one or more magnetic disks or optical disks, flash storage, etc.), as well as other types of storage. The various storages 206 may be volatile or non-volatile. Common forms of computer readable storage media include, for example, a floppy disk, a flexible disk, hard disk, magnetic tape, or any other magnetic medium, a CD-ROM, DVD, or any other optical storage medium, punchcards, papertape, or any other physical medium with patterns of holes, a RAM, a PROM, an EPROM, a FLASH-EPROM or any other type of flash memory, any memory chip or cartridge, and any other storage medium from which a computer can read.

As shown in FIG. 2, storage(s) 206 store at least several sets of executable instructions, including an operating system 212, a web browser application 208, a personal wireless network device configuration daemon 210, and a serial communications port driver 214.

In the embodiment shown in FIG. 2, the processor(s) 204 and the executable instructions 212, 210 and/or 214 may be thought of as forming a “data command requestor” that implements techniques described herein in the personal computing device 101. In such an implementation, the processors(s) 204 may be thought of as being “configured” by the executable instructions 212, 208, 210 and/or 214 to carry out the techniques in the personal computing device 101. This is just one possible implementation for the data command requestor. As an alternative, the data command requestor may be hardware implemented using a device (e.g. a programmable logic array) having an array of elements, including logic elements, wherein the elements are programmed/configured to implement techniques described herein in the personal computing device 101. As a further alternative, the data command requestor may be hardware implemented by way of another device such as an application specific integrated circuit (ASIC) having elements, including logic elements, that are constructed/configured to implement techniques described herein in the personal computing device 101. Overall, the data command requestor may be hardware implemented using any number of devices with elements, including logic elements, that are constructed/configured to implement techniques described herein in the personal computing device 101. These and other implementations of the data command requestor are possible. All such implementations are within the scope of the present invention.

The processor(s) 204 may execute the operating system 212 to provide a platform on which other sets of software (e.g., browser 208, daemon 210, and driver 214) may operate, and to execute the other software to provide additional, specific functionality. While in FIG. 2, browser 208 and daemon 210 are shown as components separate from the operating system 212. In some embodiments, some or all of the browser 208 and/or some or all of the daemon 210 may be implemented as one or more components of the operating system 212. Similarly, while the driver 214 is shown as a component of the operating system 212, the driver 214 may be a component separate from the operating system 212.

The device 101 further comprises one or more user interface components 220 coupled to the bus 202. These components 220 enable the device 100 to receive input from and provide output to a user. On the input side, the user interface components 220 may include, for example, a keyboard/keypad having alphanumeric keys, a cursor control device (e.g. mouse, trackball, touchpad, etc.), a touch sensitive screen, a microphone for receiving audio input, etc. On the output side, the components 220 may include a graphical interface (e.g. a graphics card) and an audio interface (e.g. sound card) for providing visual and audio content. The user interface components 220 may further include a display 222, a set of speakers, etc., for presenting the audio and visual content to a user. In one embodiment, the operating system 212 and the daemon 210 executed by the processor(s) 204 may provide a software user interface that takes advantage of and interacts with the user interface components 220 to receive input from and provide output to a user. This software user interface may, for example, provide a menu that the user can navigate using one of the user input devices mentioned above.

In addition to the components set forth above, the device 101 further comprises one or more communication interfaces 216 coupled to the bus 218. These interfaces 216 enable the device 101 to communicate with other components such as a personal wireless network device 103. The communication interfaces 216 may include, for example, a network interface (wired or wireless) for enabling the device 101 to send messages to and receive messages from a network. The communications interfaces 216 may further include a wireless interface (e.g. Bluetooth) for communicating wirelessly with nearby devices, and a wired interface for direct coupling with a compatible local device. These and other interfaces may be included in the device 101.

One of the communication interfaces 216 may be a serial communications port 218. Serial communications port 218 may be operatively and communicatively coupled to a personal wireless network device 103 via the serial communications mechanism 102. For example, serial communications port 218 may be an Ethernet, a FireWire, USB, infrared, or other suitable serial communications port.

### Sample Operation

With the above description in mind, and with reference to FIG. 2, operations of personal computing device 101 and personal wireless network device 103 in accordance with an embodiment of the present invention will now be described. The operations occur in the context of executing operating system 212 and in which the serial communications port 218 is operatively and communicatively coupled to a personal wireless network device 103 via a serial communications mechanism 102. For example, the personal wireless network device 103 may be connected to the serial communications port 218 via a USB-cable or dongle. The operations further occur in the context of executing personal wireless network device configuration daemon 210. The daemon 210 may execute continuously or periodically while the operating system 212 is executing. For example, an execution of the daemon 210 may be initiated in response to the establishment of the serial communications mechanism 102 between the serial communications port 218 and the personal wireless network device 103. The serial communications mechanism 102 may be established when the serial communications port 218 is operatively coupled to the personal wireless network device 103 by, for example, a cable, connector, sensor, etc. As an alternative example, the daemon 210 may be launched by the operating system 212 in conjunction with the operating system 212 boot, initialization, or startup sequence. Thereafter, the daemon 210 may run continuously as a background service or process.

### Sample CNAR Command Operation

In one embodiment, the daemon 210 sends the CNAR command via the driver 214 and serial communications port 218 to the personal wireless network device 103. In response, the daemon 201 receives the configuration network address from the personal wireless network device 103 via serial communications port 218 and the driver 214.

In one embodiment, the daemon 210, upon receiving the configuration network device, stores the received configuration network device in a storage 206 of the personal computing device 101 for later use.

In one embodiment, the daemon 210 provides a user interface displayed on the display 222 that allows a user of the personal computing device 101 to command the daemon 210 to launch a web browser 208 window directed to retrieve the web page indicated by the configuration network address. For this, the daemon 210 may retrieve a previously stored configuration network address from a storage 106 and provide the retrieved configuration network address to the web browser 208 via an Application Programming Interface (API) or on a command line. Alternatively, in response to receiving the command to launch the web browser window, the daemon 210 may send the CNAR command to the personal wireless network device 103 and launch the window using the configuration network address returned by the personal wireless network device 103 in response to the CNAR command. In both cases, the user need not know, guess, locate, or enter the configuration network address used of the personal wireless network device 103 configuration web server.

In one embodiment, the daemon 210, upon receiving the configuration network address from the personal wireless network device 103, automatically launches a web browser 208 window directed to retrieve the web page indicated by the configuration network address. For example, the daemon 210 may automatically launch the web browser 208 window after the driver 214 and/or the daemon 210 are initially installed on the personal computing device 101 as part of an initial installation and configuration procedure of the personal wireless network device 103.

### Sample BNAR Command Operation

In one embodiment, the daemon 210 sends the BNAR command via the driver 214 and serial communications port 218 to the personal wireless network device 103. In response, the daemon 201 receives the billing network address from the personal wireless network device 103 via serial communications port 218 and the driver 214.

In one embodiment, the daemon 210, upon receiving the billing network device, stores the received billing network address in a storage 106 of the personal computing device 101 for later use.

In one embodiment, the daemon 210 provides a user interface displayed on the display 222 that allows a user of the personal computing device 101 to command the daemon 210 to launch a web browser 208 window directed to retrieve the web page indicated by the billing network address. For this, the daemon 210 may retrieve a previously stored billing network address from a storage 106 and provide the retrieved billing network address to the web browser 208 via an Application Programming Interface (API) or on a command line. Alternatively, in response to receiving the command to launch the web browser window, the daemon 210 may send the BNAR command to the personal wireless network device 103 and launch the window using the billing network address returned by the personal wireless network device 103 in response to the BNAR command. In both cases, the user need not know, guess, locate, or enter the billing network address used by the radio network carrier to provide billing information.

Like with the configuration network address, the daemon 210 may generate a complete URL from a partial URL representing the billing network address that is received from the personal wireless network device 103 or pass the partial URL as received to the web browser 208.

### Sample STR Command Operation

In one embodiment, the daemon 210 sends the STR command via the driver 214 and serial communications port 218 to the personal wireless network device 103. In response, the daemon 201 receives the radio service type information from the personal wireless network device 103 via serial communications port 218 and the driver 214.

In one embodiment, the radio service type information includes (1) a number indicating radio signal strength between the personal wireless network device and the radio network (e.g., a number ranging from 0 to 5 with 0 indicating low signal strength up to 5 indicating high signal strength), (2) a character string indicating the current radio network mode (e.g., “UMTS”, “HSPA”, HSPA+”, “LTE”, etc.), and (3) a character string indicating the generation of the current radio network service (e.g., “2G”, “3G”, “4G”, etc.).

In one embodiment, the daemon 210, upon receiving the service type information, stores the received service type information in a storage 106 of the personal computing device 101 for later use.

In one embodiment, the daemon 210 provides a user interface displayed on the display 222 that visually represents the latest service type information received from the personal wireless network device 103. For example, the user interface may depict the radio signal strength as indicated by the service type information with graphical signal strength bars in which the number of bars or the number of colored or highlighted bars correspond to signal strength. Other service type information such as the current radio network mode and the generation of the current radio network service may be presented on the user interface for information purposes.

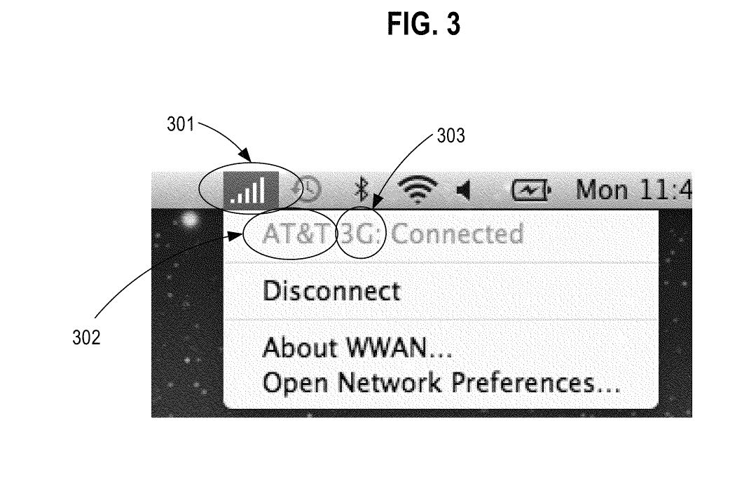

One example of a possible user interface that presents service type information obtained using the STR command is shown in FIG. 3 which is a screenshot of a user interface generated by the daemon 210 as presented on the display 222 of the personal computing device 101. The user interface of FIG. 3 is generated based in part based on a response received from the personal wireless network device 103 in response to a STR command sent from the personal computing device 101. In particular, the user interface contains visual elements 301, 302, and 303 generated based by the daemon 210 based in part on the response. Visual element 301 is signal strength bars indicating a current radio signal strength between the personal wireless network device 103 and the radio network 104. Visual element 302 is a character string indicating the current radio network mode (i.e., “AT&T”). Visual element 303 is a character string indicating the generation of the current radio network service (i.e., “3G”).

In the foregoing specification, embodiments of the present invention have been described with reference to numerous specific details that may vary from implementation to implementation. Thus, the sole and exclusive indicator of what is the invention, and is intended by the Applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer-implemented method for obtaining information from a personal wireless network device, the method comprising:
at a personal computing device operatively coupled to the personal wireless network device by a serial communications mechanism:
sending a request command to the personal wireless network device via the serial communications mechanism; and
receiving the information via the serial communications mechanism in response to sending the request command;
wherein the request command is one of:
a configuration network address request command,
a billing network address request command, or
a service type request command.

2. The method of claim 1, wherein the request command is a configuration network address request command and the information comprises a network address of a web server of the personal wireless network device.

3. The method of claim 2, wherein the configuration network address request command comprises data representing the character string CONFIGURL.

4. The method of claim 1, wherein the request command is a billing network address request command and the information comprises a network address of an Internet web site of a radio network carrier.

5. The method of claim 4, wherein the billing network address request command comprises data representing the character string BILLINGURL.

6. The method of claim 4, wherein the Internet web page provides billing information pertaining to the radio network carrier

7. The method of claim 1, wherein the request command a service type request command and the information comprises service type information pertaining to current radio connectivity between the personal wireless network device and a radio network.

8. The method of claim 7, wherein the service type information comprises:
a number reflecting a current radio signal strength,
a character string indicating a current radio network mode, and
a character string indicating a generation of a current radio network service.

9. The method of claim 7, wherein service type request command comprises data representing the character string SERVICETYPE.

10. The method of claim 1, wherein the personal computing device is a desktop computer, a laptop computer, a tablet computer, or a smart phone.

11. The method of claim 1, wherein the serial communications mechanism is Universal Serial Bus (USB)-based.

12. The method of claim 1, wherein the request command is an AT command.

13. A computer-implemented method for providing information to a personal computing device, the method comprising:
at a personal wireless network device operatively coupled to the personal computing device by a serial communications mechanism:
receiving a request command from the personal computing device via the serial communications mechanism; and
sending the information via the serial communications mechanism in response to receiving the request command;
wherein the request command is one of:
a configuration network address request command,
a billing network address request command, or
a service type request command.

14. The method of claim 13, wherein the request command is a configuration network address request command and the information comprises data representing the character string CONFIGURL.

15. The method of claim 13, wherein the request command is a billing network address request command and the information comprises data representing the character string BILLINGURL.

16. The method of claim 13, wherein the request command is a service type request command and the information comprises data representing the character string SERVICETYPE.

17. The method of claim 13, wherein the personal wireless network device is a wireless routing device or a wireless wide area network (WW AN) device.

18. A non-transitory computer-readable medium storing instructions which, when executed by one or more processors, causes a personal computing device, operatively coupled to a personal wireless network device by a serial communications mechanism, to perform a method comprising:
sending a request command to the personal wireless network device via the serial communications mechanism; and
receiving information via the serial communications mechanism in response to sending the request command;
wherein the request command is one of:
a configuration network address request command,
a billing network address request command, or
a service type request command.

19. A non-transitory computer-readable medium storing instructions which, when executed by one or more processors, causes a personal wireless network device, operatively coupled to a personal computing device by a serial communications mechanism, to perform a method comprising:
receiving a request command from the personal computing device via the serial communications mechanism; and
sending information via the serial communications mechanism in response to receiving the request command;
wherein the request command is one of:
a configuration network address request command,
a billing network address request command, or
a service type request command.

20. A device, comprising:
a serial communications port capable of operatively coupling to a personal wireless network device via a serial communications mechanism;
one or more processors;
one or more non-transitory computer-readable media storing instructions which, when executed by the one or more processors, causes the device to perform a method comprising:
sending a request command to the personal wireless network device via the serial communications mechanism; and
receiving information via the serial communications mechanism in response to sending the request command;
wherein the request command is one of:
a configuration network address request command,
a billing network address request command, or
a service type request command.

21. A device, comprising:
a serial communications port capable of operatively coupling to a personal computing device via a serial communications mechanism; and
one or more logic elements configured to:
receive a request command from the personal computing device via the serial communications mechanism; and
send information via the serial communications mechanism in response to receiving the request command;
wherein the request command is one of:
a configuration network address request command,
a billing network address request command, or
a service type request command.
